(19) United States
(12) Patent Application Publication
(10) Pub. No.: US 2026/0353477 A1
(43) Pub. Date: Nov. 5, 2026

(54) SYSTEM AND METHOD FOR DYNAMICALLY MAPPING DATA NETWORK NAMES AND SELECTING NETWORK FUNCTIONS IN MULTI-ACCESS CONVERGED CORE NETWORKS

(71) Applicant: AT&T Intellectual Property I, L.P., Atlanta, GA (US)

(72) Inventor: Rajendra Prasad Kodaypak, Sammamish, WA (US)

(73) Assignee: AT&T Intellectual Property I, L.P., Atlanta, GA (US)

(21) Appl. No.: 19/195,863

(22) Filed: May 1, 2025

(51) Int. Cl. H04W 76/10; H04W 48/18; H04W 60/00

(52) U.S. Cl. CPC H04W 76/10; H04W 48/18; H04W 60/00

(57) ABSTRACT

Aspects of the subject disclosure may include, for example, an apparatus, including: a processing system including a processor; and a memory configured to store executable instructions that, when executed by the processor, cause the apparatus to: receive, via one or more interfaces, network access parameters associated with a registration request from a user equipment; determine, based on the network access parameters and provisioning information for a data network name (DNN) of a data network, a mapping between the DNN and a plurality of available network functions deployed in a converged core network; select one or more network functions from the plurality of available network functions to provide service the user equipment; generate control signals to dynamically orchestrate provisioning and session establishment via the one or more network functions selected; and communicate the control signals to the one or more network functions selected. Other embodiments are disclosed.

### FIELD OF THE DISCLOSURE

The subject disclosure relates to a system and method for dynamically mapping data network names and selecting network functions in multi-access converged core networks.

### BACKGROUND

A multi-access converged core network is an advanced telecommunications architecture designed to integrate and manage multiple types of access technologies within a single, unified core network infrastructure. This type of network supports both wireless and wireline access methods, allowing for seamless connectivity and service delivery across various platforms. The industry is increasingly converging wireless and wireline technologies into integrated architectures that support a wide range of digital endpoints. This evolution has driven the development of systems that incorporate cloud native processing and virtualized network elements to achieve seamless connectivity across heterogeneous access mediums. As global standards continue to mature, network architectures are expected to support both traditional and emerging broadband services in a unified framework, thereby creating a dynamic environment where multiple access technologies coexist.

Broadband connectivity solutions are now being pursued with the objective of delivering ultra-reliable, high-speed, and consistently available data services to an expansive subscriber base. Operators seek to achieve efficiency in session establishment, resource allocation, and traffic orchestration while maintaining stringent requirements for reliability and low latency. The goals include ensuring that networks can adapt to varying load conditions, handle diverse data flows, and unify management across different access modes. In this context, intelligent orchestration mechanisms, responsive to network performance metrics and user demands, are becoming a critical component of modern system design.

### BRIEF DESCRIPTION OF THE DRAWINGS

Reference will now be made to the accompanying drawings, which are not necessarily drawn to scale, and wherein:

FIG. 1A is a block diagram illustrating an exemplary, non-limiting embodiment of a communications network in accordance with various aspects described herein.

FIG. 1B is a block diagram illustrating details of an exemplary core network functioning within the communication network of FIG. 1A in accordance with various aspects described herein.

FIG. 2A is a block diagram illustrating an example, non-limiting embodiment of a system architecture for gateways within a multi-access converged core network in accordance with various aspects described herein.

FIG. 2B is a block diagram illustrating an example, non-limiting embodiment of edge aggregation of user plane functions for wireline access in a multi-access converged core network in accordance with various aspects described herein.

FIGS. 2C and 2D are charts that illustrate an example, non-limiting embodiment of network mappings for converged core control plane selection.

FIGS. 2E and 2F are charts that illustrate an example, non-limiting embodiment of network slice to data network mappings for converged core control plane selection.

FIG. 2G illustrates an illustrative embodiment of a method for dynamically mapping data network names and selecting network functions in a multi-access converged core network infrastructure in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for mapping user equipment to network services provided by network functions in a converged core network. Other embodiments are described in the subject disclosure.

One or more aspects of the subject disclosure include an apparatus, including: a processing system including a processor; and a memory configured to store executable instructions that, when executed by the processor, cause the apparatus to: receive, via one or more interfaces, network access parameters associated with a registration request from a user equipment; determine, based on the network access parameters and provisioning information for a data network name (DNN) of a data network, a mapping between the DNN and a plurality of available network functions deployed in a converged core network; select one or more network functions from the plurality of available network functions to provide service the user equipment; generate control signals to dynamically orchestrate provisioning and session establishment via the one or more network functions selected; and communicate the control signals to the one or more network functions selected.

One or more aspects of the subject disclosure include a non-transitory machine-readable medium, with executable instructions that, when executed by a processing system including a processor, facilitate performance of operations of: receive network access parameters associated with a registration request from a user equipment in a converged core network; retrieve provisioning data for a data network name (DNN) from a unified data management system; determine, based on the network access parameters, the provisioning data, and location-based information, a dynamic mapping between the DNN and a plurality of available network functions deployed in the converged core network; select one or more network functions from the plurality of available network functions; generate control signals to dynamically orchestrate provisioning and to establish session connectivity for the user equipment via the network functions selected; and periodically re-evaluate the dynamic mapping by retrieving updated network performance metrics and geo-location data to adjust the dynamic mapping in response to variations in network load, energy consumption parameters, and endpoint mobility.

One or more aspects of the subject disclosure include a method of: receiving, by a processing system including a processor, a registration request from a user equipment, the registration request including network access parameters comprising a tracking area identifier, a radio access technology type, and network slice information for a network; retrieving, by the processing system from a unified data management system, provisioning information associated with a data network name (DNN); dynamically determining, by the processing system executing a dynamic mapping algorithm, a mapping between the DNN and a plurality of available network functions deployed in the network, the mapping being based on the network access parameters and geographic location data for the user equipment; selecting, by the processing system based on the mapping, one or more network functions that satisfy predetermined criteria including slice awareness, energy efficiency, and real-time network load conditions; generating, by the processing system, configuration commands to dynamically provision the network functions selected and to establish session connectivity for the user equipment; and transmitting, by the processing system, the configuration commands to the network functions selected.

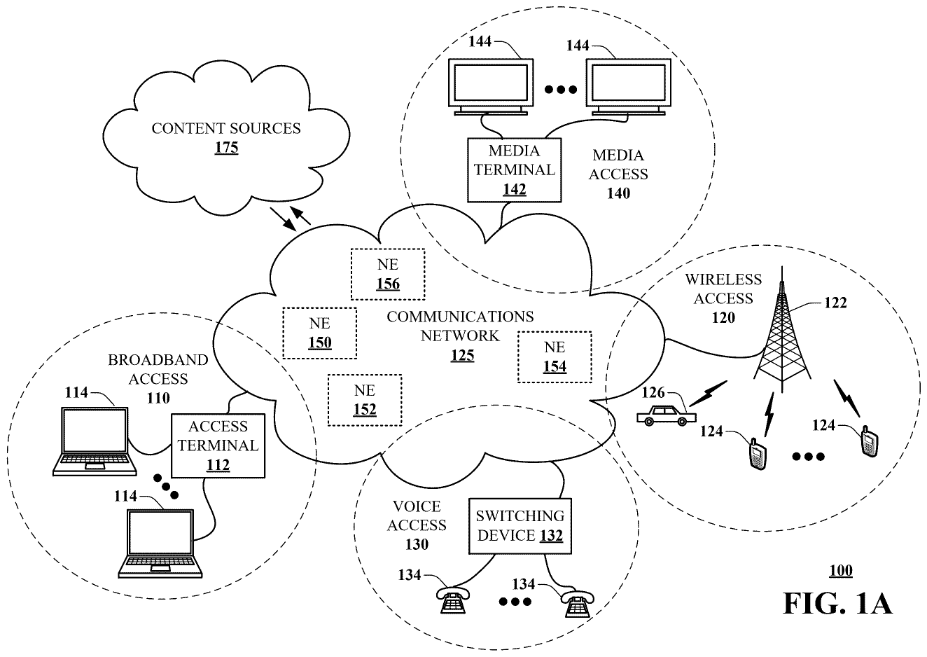

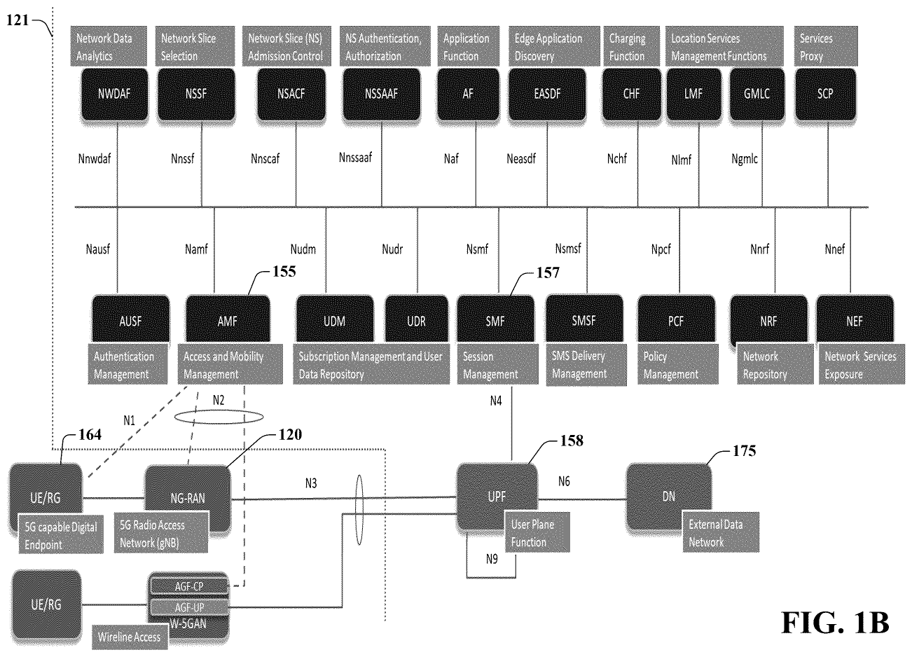

Referring now to FIG. 1A, a block diagram is shown illustrating an example, non-limiting embodiment of a system 100 in accordance with various aspects described herein. For example, system 100 can facilitate in whole or in part receive network access parameters associated with a registration request from a user equipment; determine a mapping between a data network name and a plurality of available network functions deployed in a converged core network; select one or more network functions to provide service the user equipment; generate control signals to provision and establish sessions; and communicate the control signals to the one or more network functions selected. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on). Collectively, data terminal 114, mobile devices 124, vehicle 126, media terminal 142 are also known as user equipment (UE).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a fourth generation (4G), fifth generation (5G), or next generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

FIG. 1B is a block diagram illustrating details of an exemplary core network functioning within the communication network of FIG. 1A in accordance with various aspects described herein. As shown to the right of the dotted line 121 in FIG. 1B, a 5G core serves as the overarching core network supporting the operations of the network. Within this 5G core, several critical control plane functions are housed, each playing a distinct role in managing network operations.

An Access and Mobility Management Function (AMF 155) in the control plane is responsible for handling UE registration, mobility management, and maintaining connections to the network. Standards define factors used by AMF 155 to select a Session Management Function (SMF 157), which oversees session management tasks, including the establishment, modification, and release of user sessions for the UEs.

The core network also includes a suite of other network functions, such as the Network Slice Selection Function (NSSF), Network Exposure Function (NEF), Network Repository Function (NRF), Policy Control Function (PCF), Unified Data Management (UDM), Network Data Analytics Function (NWDAF), Authentication Server Function (AUSF), and Service Communication Proxy (SCP). These functions collectively manage network policies, authentication processes, data analytics, and service exposure, ensuring seamless operation and service delivery.

In the user plane section to the left of dotted line 121, user equipment (UE 164) represents devices like smartphones and tablets that access the network. UEs communicate wirelessly through a radio access network (RAN 120), which facilitates the connection between the UEs and the core network. A User Plane Function (UPF 158) is responsible for routing and forwarding data traffic between the user equipment and external data networks, represented by a data network (DN 175).

FIG. 1B also illustrates several key interfaces that connect these components. The N1 interface links UE 164 to AMF 155 for signaling and control purposes. The N2 interface connects RAN 120 to AMF 155, facilitating communication between the radio access network and the core network. The N3 interface links RAN 120 to UPF 158, enabling the flow of data traffic between UE 162 and DN 175. The N4 interface connects SMF 157 to UPF 158, managing session-related data traffic, while the N6 interface connects the UPF 158 to the DN 175, allowing data exchange between the user plane function and external data networks. Overall, FIG. 1B provides a comprehensive view of the core network architecture, illustrating how various network functions interact to manage user connectivity and data traffic within a multi-access converged core network. Although FIG. 1B illustrates a simplified block diagram, with single instances of UPF 158, DN 175 and a UE 164, one must consider that in a typical 5G or next generation network, hundreds or more UPFs and DNs may be present, providing data traffic service to thousands or even millions of UEs and other devices.

In a converged broadband access network that supports Third Generation Partnership Project (3GPP) and Non-3GPP/wireline access technologies, the UE could connect via a next generation radio access network (NG-RAN), Trusted/Untrusted Wi-Fi (N3IWF/TNGF), or wireline 5G access (W-5GAN) to the core network (5GC), such as communications network 125, which acts as a converged 5G core. In a 5G wireline fixed access network connected to the converged 5GC via Wireline Access Gateway Function (W-AGF-BBF), UE 164 could be behind a residential gateway (5G-RG), and it could get connected to the converged 5GC via both NG-RAN and Wireline 5G RAN. Since the W-5GAN also supports fixed access network connectivity for cable and broadband fiber customers, fixed network residential gateway (FN-RG) could be used to connect to the converged 5GC via the W-AGF-BBF. Given FN-RG devices are not 5G capable, they do not support native non-access stratum (NAS) signaling and thus the W-AGF-BBF terminates the N1 interface on its behalf.

The W-AGF-BBF interfaces with the converged 5GC network control and user plane functions via both the N2 and N3 interfaces, respectively. As part of the N2 interface setup, the W-AGF-BBF provides its configured tracking area identity (TAI) to AMF 155. When a 5G-RG is connected via a NG-RAN and via a W-5GAN, multiple N1 interface instances can exist for the 5G-RG implying that there shall be one N1 instance over NG-RAN and one N1 instance over W-5GAN. Thus, a 5G-RG simultaneously connected to the converged 5GC network of a carrier public land mobile network (PLMN) over a 3GPP access and a W-5GAN access can be served by a single anchor AMF in this 5GC Network. A UE connected behind the FN-RG could still connect to the 5GC via N3IWF or TNGF. Similarly, a UE connected via Wi-Fi to 5G-RG could be connected to the same converged 5GC via N3IWF.

When multiple W-AGF-BBF instances are deployed in data centers to serve 5G-RG users across a large geographic region, they can be configured with unique TAIs. For example, if there are two W-AGF-BBFs in two separate locations configured with their unique TAIs, the UEs served by a specific W-AGF-BBF will be based on the specific TAI location where they register from. When the UE's register from a given location via non-3GPP access, the AMF serving the access network allocates a registration area which is the tracking area it received from the serving W-AGF-BBF. This TAI will not change until the UE deregisters explicitly or implicitly upon an idle timer expiry from the non-3GPP access technology.

The latest release of 3GPP standards indicates that each W-AGF-BBF can be configured with a different TAI value or with the same value as other W-AGF-BBFs. Having the same TAI value causes confusion for interpretation by vendor implementations and could potentially result in TAI conflicts/pollution if not properly designed, controlled and managed by the network management system of the mobile network operator (MNO) governing the W-AGF-BBF and AMF network functions. As both functions handle critical NAS signaling transactions towards 3GPP and Non-3GPP/W-5GAN access, accurate location-based Node-TAI mapping, orchestration and management is extremely critical for simplified and flawless operations.

Lack of proper network traffic forecasts, location-based services dimensioning, W-AGF-BBF network function to TAI mapping, W-AGF-BBF pooling, dynamics of mobility patterns, and AI data driven network insights could impact the service orchestration process with suboptimal core network functions selection. This could in turn result in ineffective utilization of core network infrastructure resources in the geo-targeted regions thereby impacting end user PDU session establishment, data connectivity, customer satisfaction, quality of experience and potential customer churn.

Once the serving AMF retrieves the DNN information from the UDM during UE/5G-RG registration procedure, the AMF could use that subscription data along with the UE/5G-RG requested PDU session establishment request metadata to perform intelligent SMF selection. During the SMF discovery and selection process via the 5GC-NRF, the AMF shall take into consideration DNN, S-NSSAI, NSI ID, Access Technology being used by the UE/5G-RG and its location such as the Tracking Area, SMF loading, as well as any local operator policies within AMF.

While the 3GPP standards defined selection process provides AMF with the SMF instances required to select and complete the PDU session, an AMF-SMF selection process within a multi access converged core network could be enriched with innovative Access-Region-Node-Tracking Area-Slice Aware-Energy Efficiency Aware-DNN mapping methodology. Such intelligence is required in the converged core network functions such as AMF and their configuration management systems aligned with the W-AGF-BBF nodes to dynamically orchestrate, provision, manage, control, switch and operate such critical network function resources. In addition, the digital endpoints (UE/5G-RG) being connected via specific location dependent access, slice-aware and service enablement technology to the cloud native converged core network shall be delivered with ultra-reliable connectivity, flawless operation and impeccable services delivery.

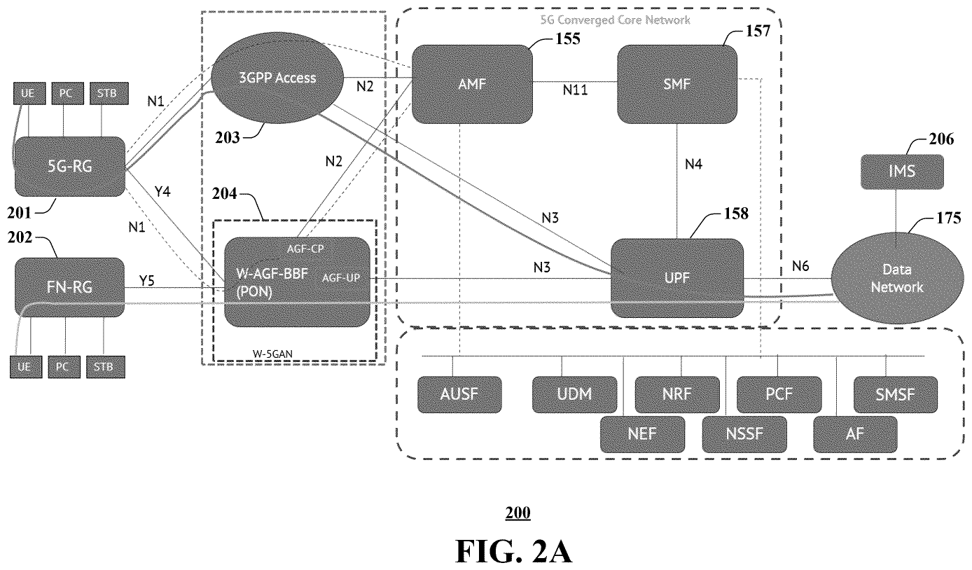

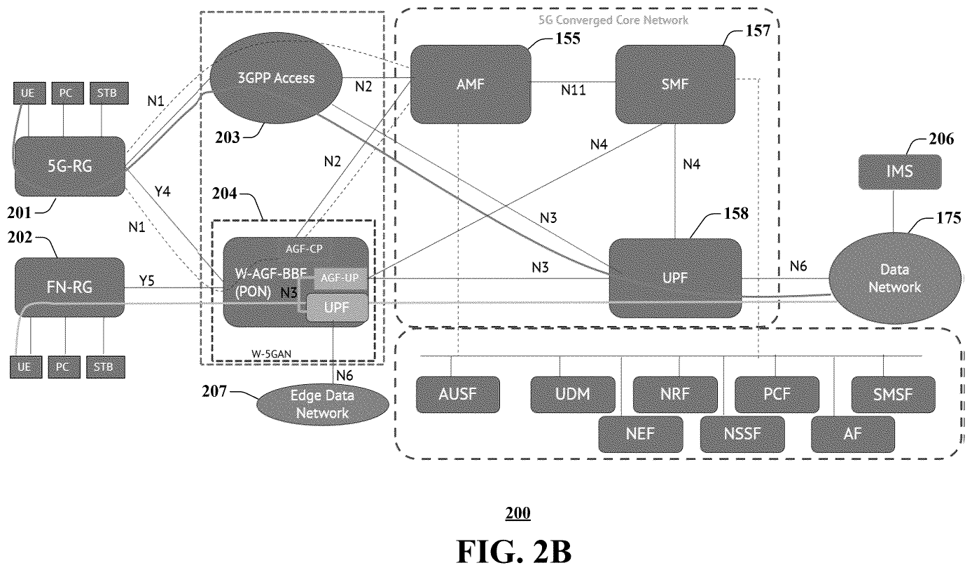

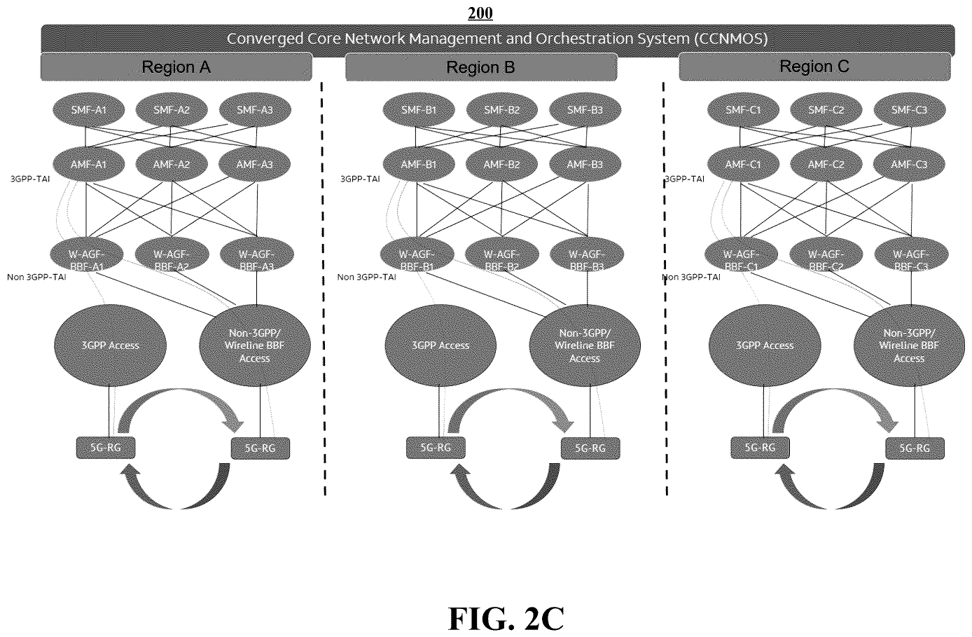

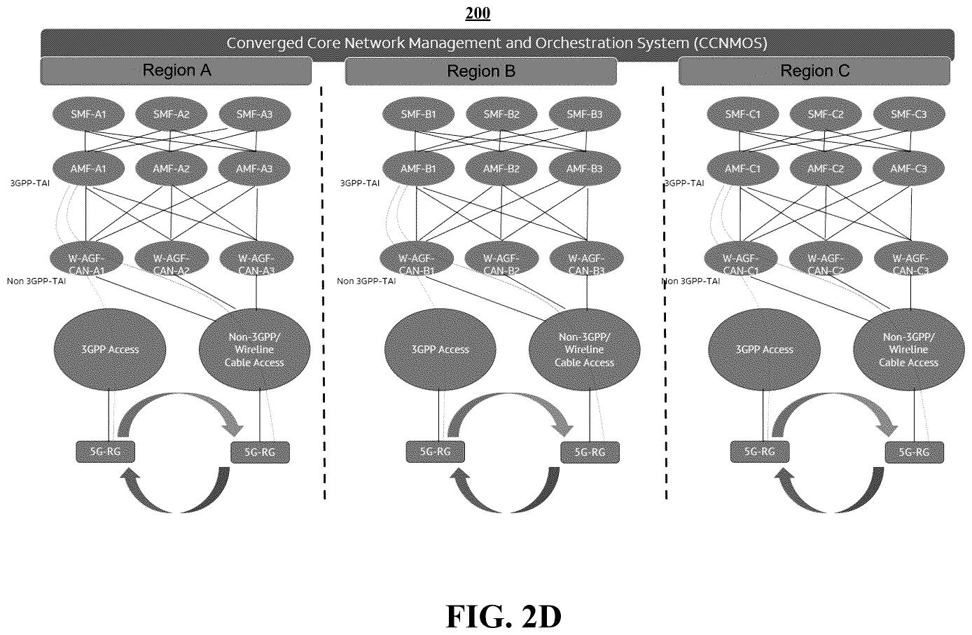

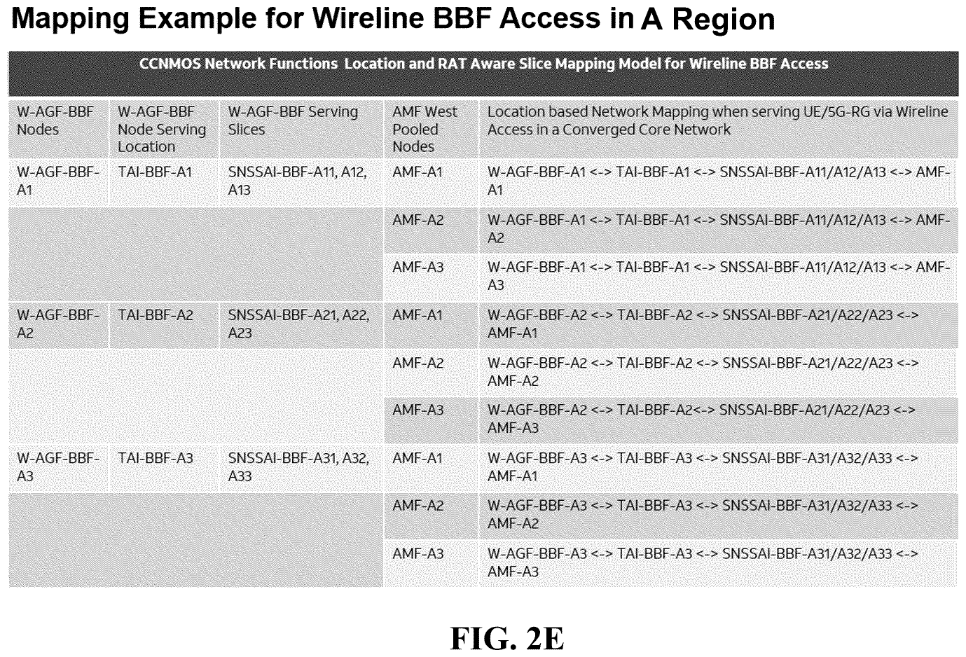

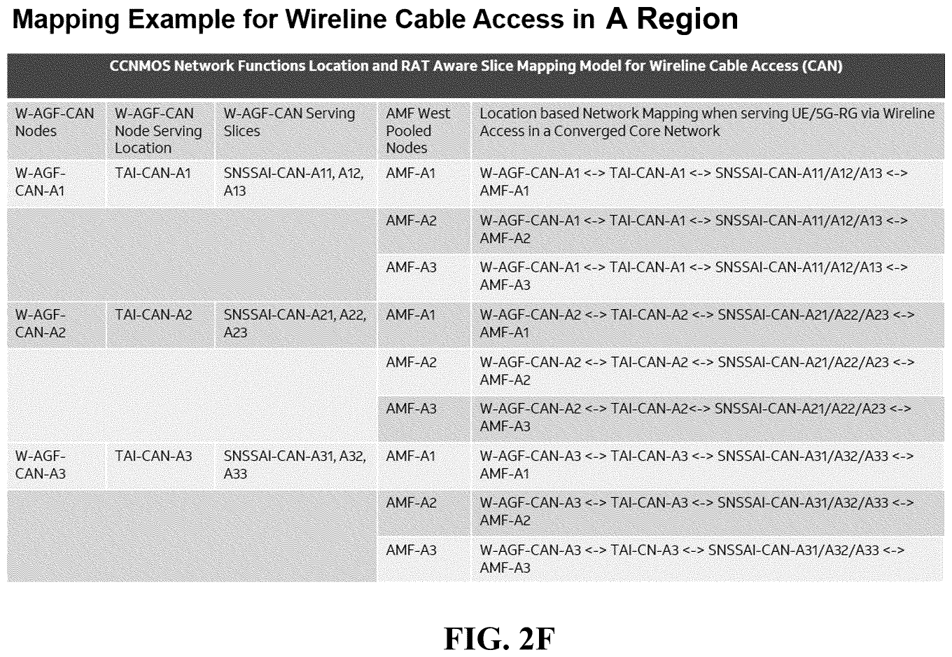

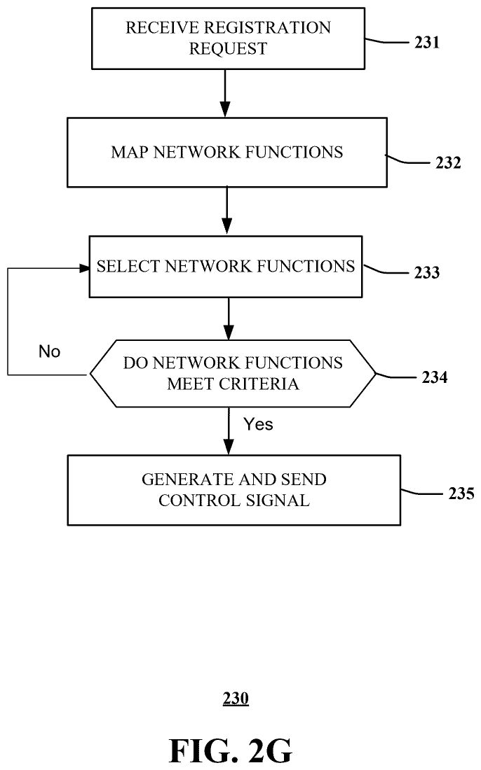

FIG. 2A is a block diagram illustrating an example, non-limiting embodiment of a system architecture for 5G-RG and FN-RG gateways within a multi-access converged core network in accordance with various aspects described herein. As shown in FIG. 2A, a cloud converged core network management and orchestration system (CCNMOS 200) orchestrates core network functions supporting multi-access networks with geo-location TAI-based Node-TAI-DNN-Slice Aware mapping, peer network functions discovery, and selection of network functions. The system includes 5G-RG 201, FN-RG 202, 3GPP Access 203, W-5GAN 204 and a core network comprising functions including: AMF 155, SMF 157, UPF 158, AUSF, UDM, NRF, PCF, SMSF, NEF, NSSF and AF. UPF 158 is coupled to a data network DN 175 and IMS 206. These components interact to enable seamless connectivity and service delivery across wireless and wireline access technologies. 5G-RG 201 serves as a residential gateway that facilitates the connection of user equipment, including UE, PC and STB, to the converged network infrastructure. 5G-RG 201 accommodates both wireless 3GPP Access 203 and wireline access technologies, allowing concurrent connectivity through various access modes. 5G-RG 201 communicates with the AMF 155 using the N1 interface for signaling and control functions.

FN-RG 202 is a fixed network residential gateway that connects similar user equipment to the converged core network infrastructure. Unlike 5G-RG 201, FN-RG 202 does not support native non-access stratum signaling. Instead, FN-RG 202 relies on W-AGF-BBF (PON) to terminate the N1 interface on behalf of the gateway. FN-RG 202 communicates with the AMF 155 through the Y5 interface.

3GPP Access 203 facilitates wireless connectivity for user equipment, such as mobile devices, through the N2 interface to AMF 155. This component ensures seamless communication between the radio access network and the converged core network, supporting mobility and session management.

W-5GAN 204 serves as the wireline access gateway for Passive Optical Networks (PON), providing connectivity for FN-RG 202 devices. The system interfaces with AMF 155 via the N2 interface and with UPF 158 via the N3 interface, enabling data traffic routing and session management for wireline access technologies.

AMF 155 serves as a control plane function tasked with managing UE registration, mobility handling, and maintaining connections to the network. This function communicates with SMF 157 through the N11 interface to manage session-related activities, such as the initiation, adjustment, and termination of user sessions.

SMF 157 manages session-related data traffic and interacts with UPF 158 via the N4 interface. SMF 157 is responsible for selecting and provisioning network functions based on DNN mapping and other criteria.

UPF 158 is a user plane function responsible for routing and forwarding data traffic between user equipment and external data networks. UPF 158 connects to DN 175 via the N6 interface, facilitating efficient data exchange and connectivity.

DN 175 represents external data networks that provide services and content to user equipment. These external data networks interact with UPF 158 to facilitate data traffic flow and service delivery.

AUSF manages authentication processes for user equipment, facilitating secure access to the network. This component engages with other control plane functions to uphold network security.

UDM manages subscription data and provisioning information for user equipment. During the registration and session establishment processes, UDM supplies data to AMF 155.

NRF facilitates the discovery and selection of network functions within the converged core infrastructure. This process supports resource allocation and function selection in alignment with network policies and performance metrics.

PCF oversees network policies and ensures adherence to operator-defined rules. PCF engages with other control plane functions to implement policy decisions.

SMSF supports short message service functionalities within the network, enabling communication between user equipment and external messaging platforms.

NEF exposes network services and capabilities to external applications, facilitating integration and service delivery across domains.

NSSF handles network slice selection, ensuring that user equipment is connected to the appropriate slice based on service requirements and network conditions.

AF represents application functions that interact with the network to provide services and content to user equipment. These application functions interface with other network functions to facilitate seamless service delivery.

IMS 206 facilitates IP multimedia services, enabling voice, video, and other multimedia communications for user equipment. This system engages with DN 175 and additional network functions to deliver broad service capabilities.

CCNMOS 200 is a composite function that handles aggregate control plane signaling and user traffic for wireline access technologies in addition to 3GPP access. In an embodiment, CCNMOS 200 is dedicated as a separate cloud native instance for each of 3GPP, Non-3GPP and Wireline BBF/Cable Access technologies. For example, the converged core network handling control plane could be a composite function implemented as W-AGF-BBF-CP or W-AGF-CAN-CP and AMF. Similarly, the user plane functions for wireline access could be a composite function consisting of W-AGF-BBF-UP or W-AGF-CAN-UP depending on BBF/CAN access and UPF network functions.

Depending on the operator deployment models, CCNMOS 200 functions in an open disaggregated network could be co-hosted with Open RAN control and user plane functions such as the O-CU-CP and O-CU-UP. For example, in certain mission critical enterprise 5G edge computing deployment models, the W-AGF-BBF or W-AGF-CAN network function with control and user plane separation can be co-located with 5GC network functions as well as certain Open RAN network functions in a disaggregated open networking model.

Due to the additional complexity of handling signaling and user traffic from both 3GPP, Non-3GPP and Wireline access technologies, the next generation converged core network functions serving wireless and wireline users need to be orchestrated, configured, managed, controlled and maintained. A unified network management using CCNMOS 200 allows for operational simplicity in terms of streamlined digital endpoints connectivity across multi-access, service delivery, data collection and reporting, converged core network functions faults/events, configuration, performance monitoring and taking proactive actions to rapidly resolve any CP call processing and UP data transfer issues identified in the network.

Because of software defined disaggregated and open telecom network evolution, CCNMOS 200 may be implemented as an aggregated multi-access control plane function that handles access, transport and core network domains. Hence the next generation converged core control plane network management and orchestration using CCNMOS 200 becomes extremely critical to validate the network functions selection, interoperability between access-core, call processing functionality, data processing integrity and root cause detection based on fine grained control plane traffic events across the signaling interfaces distributed across these domains.

In another embodiment, converged core user plane network functions could be an aggregated multi-access user plane function that needs fine grained monitoring using CCNMOS 200 to validate the coordinated user plane functions selection by the control plane functions, interoperability between access-core, call processing functionality, data processing integrity and root cause analysis across the user plane interfaces distributed across these domains.

Delivering reliable connectivity with optimal network functions selection based on intelligent geo-location nodal mapping, high-quality energy efficient and slice aware services to wireless and wireline subscribers in a multi-access converged core networking domain in public, private, and hybrid cloud networking environments requires complete visibility and real-time, automated assurance with integrated AI-powered analytics for intelligent network management and proactively resolve degradations before their occurrence in ensuring superior customer experiences. CCNMOS 200 facilitates handling such complex management tasks.

CCNMOS 200 can be dynamically configured to function as an integrated network management system across the multi-access, transport and core networking domains with cross-domain mapping and traffic correlators for targeted end-to-end application performance metrics and KPI/KCI evaluation. In addition, CCNMOS 200 orchestrates broadband access domain-specific geo-location Node-TAI-slice-specific management with integrated slice-mapping functions and associated slice specific latency across each domain. CCNMOS 200 is also capable of ingesting the latency APIs from each of the multi access and core domain management systems at the slice level.

Global broadband communication service providers deploying wireless and wireline access networks using a cloud native converged core network can effectively utilize their geo-location node-location-slice-DNN aware mapping functions orchestrated by CCNMOS 200 within the multi access network for cross-domain resources reservation, mobility, session, policy management, charging, billing and control decisions taking into consideration key aspects such as user location, access technology, capacity and coverage performance, traffic density, UAV devices and applications with targeted quality of service in the most efficient, cost-effective and timely manner.

FIG. 2B is a block diagram illustrating an example, non-limiting embodiment of edge aggregation of user plane functions for wireline access in a multi-access converged core network in accordance with various aspects described herein. As shown in FIG. 2B, wireline user plane functions AGF-UP are aggregated in W-5GAN 204 along with UPF 158 and configured to provide broadband fixed and mobile data services from edge data network 207. Aggregating the converged core 5G user plane function (UPF) at the edge location along with the AGF-UP function enables operators a flexible, scalable architecture design and implementation to drive mission critical and latency sensitive services to the mobile users along with the fiber broadband users from the same location. The PDU Session anchored UPF could be optimized to handle non-mission-critical services associated with the 5G-RG/FN-RG users while supporting mission critical services with the edge UPF collocated with the AGF-UP. Such user plane aggregation results in effective utilization of cloud computing resources across both fiber broadband and wireless customers when delivering wireless services that demand strict Service Level Agreements (SLAs) in a given location.

FIGS. 2C and 2D are charts that illustrate an example, non-limiting embodiment of CCNMOS mappings for converged core control plane selection. FIGS. 2C and 2D illustrate a three-region (A/B/C) deployment model as an example for the converged core control plane functions including AMF and SMF. A network operator may have network infrastructure assets supporting wireline BBF (FIG. 2C) and Cable (FIG. 2D) access in certain geographical locations that serve customers intending to leverage new services that will be served by the converged core network. Hence the network operator needs to have a proper network mapping methodology to ensure that there is no pollution of node-RAT-location-slice mapping to deliver targeted services based on the supported RAT types in their geographical locations.

Key features of this deployment use case using CCNMOS orchestration use three AMF nodes (AMF-A1, AMF-A2, AMF-A3) deployed in the A Region in a single pooled configuration based on network dimensioning to account for network resiliency, operator maintenance and/or software upgrades as well as capacity handling during normal operation and failovers. These three AMFs support control plane connectivity from 3GPP RAN and Wireline 5GRAN network functions to allow for the end users to register with them via appropriate access nodes.

These three AMFs are connected to a pool of three SMFs (SMF-A1, SMF-A2 and SMF-A3) for discovery and selection to proceed with control plane PDU session establishment procedures. To complete the PDU session establishment procedures, these SMFs could select an appropriate User Plane Function (UPF)—standalone or combined with W-AGF-BBF-UP based on the discovery and selection process within the SMF as well as based on local operator policies as configured by the CCNMOS.

As shown in FIG. 2C, there are three W-AGF-BBF nodes (W-AGF-BBF-A1, W-AGF-BBF-A2, W-AGF-BBF-A3) deployed in the A Region. Each of these W-AGF-BBF nodes serve a dedicated location area which is designated by an appropriate Tracking Area Identity (TAI-BBF-A1, TAI-BBF-A2, TAI-BBF-A3) respectively. Each of these W-AGF-BBF nodes will have their internal redundancy to handle network function resiliency.

As shown in FIG. 2D, there are three W-AGF-CAN nodes (W-AGF-CAN-A1, W-AGF-CAN-A2, W-AGF-CAN-A3) deployed in the A Region. Each of these W-AGF-CAN nodes serve a dedicated location area which is designated by an appropriate Tracking Area Identity (TAI-CAN-A1, TAI-CAN-A2, TAI-CAN-A3) respectively. Each of these W-AGF-CAN nodes will have their internal redundancy to handle network function resiliency.

The W-AGF-BBF and W-AGF-CAN nodes are connected to a pool of 3 AMFs for discovery and selection to proceed with the N2 interface setup procedure. The pooled regional AMF deployment allows for resilient connectivity to any AMF within the pool in case of N2 interface connectivity issues, transport link failures, AMF network function failures. When these W-AGF nodes setup their N2 interface procedure with the pooled AMFs, they indicate their Global W-AGF ID as part of the Global RAN Node ID. The AMF determines the RAT Type Wireline BBF versus CAN access based on the W-AGF User Location Information and uses this information to map the RAT type to the TAC for subsequent peer network selection process.

In an embodiment, CCNMOS 200 dynamically configures and aligns accurate mapping of the DNNs in the AMF along with the RAT Type, Tracking Area and Slice awareness in a given location serving end users connecting with specific Wireline access types to ensure there is no DNN pollution when requesting session establishment with the SMF peer nodes.

FIGS. 2E and 2F are charts that illustrate an example, non-limiting embodiment of CCNMOS slice to data network mappings for converged core control plane selection. FIGS. 2E and 2F illustrate how CCNMOS 200 maps the W-AGF-BBF and W-AGF-CAN nodes serving a dedicated TAI to support three slices designated uniquely.

As shown in FIG. 2E for RAT Type=Wireline BBF Access, the CCNMOS mapping will be:
W-AGF-BBF-A1 serving TAI-BBF-A1 will serve three network slices designated by SNSSAI-A11, SNSSAI-A12, SNSSAI-A13 and three DNNs: W-AGF-BBF-A1<->TAI-BBF-A1<->SNSSAI-BBF-A11/A12/A13<->AMF-A1, AMF-A2 and AMF-A3<->DNN-BBF-A11/A12/A13;
W-AGF-BBF-A2 serving TAI-BBF-A2 will serve three network slices designated by SNSSAI-A21, SNSSAI-A22, SNSSAI-A23 and three DNNs: W-AGF-BBF-A2<->TAI-BBF-A2<->SNSSAI-A21/A22/A23<->AMF-A1, AMF-A2 and AMF-A3<->DNN-BBF-A21/A22/A23
W-AGF-BBF-A3 serving TAI-BBF-A3 will serve three network slices designated by SNSSAI-A31, SNSSAI-A32, SNSSAI-A33 and three DNNs: W-AGF-BBF-A3<->TAI-BBF-A3<->SNSSAI-A31/A32/A33<->AMF-A1, AMF-A2 and AMF-A3<->DNN-BBF-A31/A32/A33

As shown in FIG. 2F for RAT Type=Wireline CAN Access, the CCNMOS mapping will be:
W-AGF-CAN-A1 serving TAI-CAN-A1 will serve three network slices designated by SNSSAI-A11, SNSSAI-A12, SNSSAI-A13 and three DNNs: W-AGF-CAN-A1<->TAI-CAN-A1<->SNSSAI-A11/A12/A13<->AMF-A1, AMF-A2 and AMF-A3<->DNN-CAN-A11/A12/A13
W-AGF-CAN-A2 serving TAI-CAN-A2 will serve three network slices designated by SNSSAI-A21, SNSSAI-A22, SNSSAI-A23 and three DNNs: W-AGF-CAN-A2<->TAI-CAN-A2<->SNSSAI-A21/A22/A23<->AMF-A1, AMF-A2 and AMF-A3<->DNN-CAN-A21/A22/A23
W-AGF-CAN-A3 serving TAI-CAN-A3 will serve three network slices designated by SNSSAI-A31, SNSSAI-A32, SNSSAI-A33 and three DNNs: W-AGF-CAN-A3<->TAI-CAN-A3<->SNSSAI-A31/A32/A33<->AMF-A1, AMF-A2 and AMF-A3<->DNN-CAN-A31/A32/A33

Such a systematic Node ID-RAT Type-Tracking Area-Slice Aware-DNN Core Network mapping methodology orchestrated by CCNMOS 200 allows the operator to effectively plan their Slice-DNN traffic dimensioning based on anticipated regional forecasts across the multi access Wireline technologies in addition to their Wireless Access and drive multi-access network planning, evolution in that region to offer optimal as well as new targeted services delivery. The DNNs could be provisioned in the subscription data profile of the users and when the AMF retrieves the subscription data during the registration procedure, it stores these DNNs locally.

In an embodiment, CCNMOS 200 performs the above-described systematic mapping within the converged core AMF based on the metadata within the AMF, incoming requests from end users, RAT Type supported in a given region using specific Wireline technology. Based on the traffic dynamics and performance metrics, CCNMOS 200 could be used to provide network optimization with location area (TAI) splitting to reduce the blast radius of the W-AGF node serving area and impacted services for multi access specific (BBF/CAN) technologies per Slice-DNN and dynamic provisioning of on-demand new services with geo-targeted DNNs.

As the standards evolve across wireline domains to converge with wireless access into a common core network infrastructure, the broadband service providers now have the challenge of integrating these access domain specific platforms along with the core network into a converged core network management and orchestration (CCNMOS) layer. Such a unified management layer across the converged core networking domains will help network operators to simplify their core network monitoring solutions with a single-pane-of-glass view across their network.

The new DNN network mapping methodology proposed in this disclosure can be used by CCNMOS 200 to make an intelligent decision on dynamically creating, modifying and deleting the location-based converged core network functions for mobility, wireline access and services delivery workloads that are extremely sensitive to connectivity, capacity, latency etc. For example, a network operator can steer device, intent, slice, application and service level agreement (SLA) compliant traffic flows from a wide variety of geo-targeted digital endpoints to the right multi-access networks at the individual slice level with targeted DNNs mapped as allowed per location without access restrictions.

With such converged core network assisted management intelligence, wireless customers served by open RAN can be served with distributed RAN network functions connected by Wireline Cable and BBF transport slice paths based on aggregate traffic demands, device types, priorities, geo-location, slice-aware, allowed DNNs for services, application and slice-DNN aware SLA delivery. The disclosed system and method are critical to drive smarter and rapid traffic correlations in real time based on end-to-end application/service flows, node-RAT Type-slice-DNN domain specific behaviors and actionable slice-DNN management triggers to optimize multi-access domain specific and converged core network infrastructure resources.

FIG. 2G illustrates an illustrative embodiment of a method for dynamically mapping data network names and selecting network functions in a multi-access converged core network infrastructure in accordance with various aspects described herein. The method 230 can be implemented by a processing system including a processor and memory, as described in the claims. The method 230 facilitates the orchestration of network functions to provide seamless connectivity and service delivery for user equipment. As shown in FIG. 2G, the method begins at step 231 where the system receives a registration request from user equipment. In an embodiment, the registration request includes network access parameters such as a tracking area identifier, radio access technology type, network slice information, or a combination thereof. These parameters are required to initiate the process of mapping and selecting network functions.

Next at step 232, the system maps network functions based on the network access parameters and provisioning information for a data network name associated with the user equipment. The mapping process identifies a plurality of available network functions deployed in the converged core network and establishes a relationship between the data network name and these network functions.

At step 233, the system selects one or more network functions from the plurality of available network functions to provide service to the user equipment. The selection process may utilize a dynamic mapping algorithm that integrates slice awareness, energy efficiency criteria, and geographic location information to optimize the selection of network functions.

At step 234, the method 230 evaluates whether the selected network functions meet predefined criteria. These criteria may include network load conditions, energy efficiency metrics, and user equipment location and mobility parameters. If the selected network functions do not meet the criteria, the method 230 loops back to step 233 to reselect network functions. If the criteria are met, the method proceeds to the next step.

At step 235, the method 230 generates and sends control signals to the selected network functions. These control signals include configuration commands for dynamically provisioning the network functions and establishing session connectivity for the user equipment. This step ensures that the selected network functions are appropriately configured to deliver the required services.

While for purposes of simplicity of explanation, the respective processes are shown and described as a series of steps in FIG. 2G, it is to be understood and appreciated that the claimed subject matter is not limited by the order of the steps, as some steps may occur in different orders and/or concurrently with other steps from what is depicted and described herein. Moreover, not all illustrated steps may be required to implement the methods described herein.

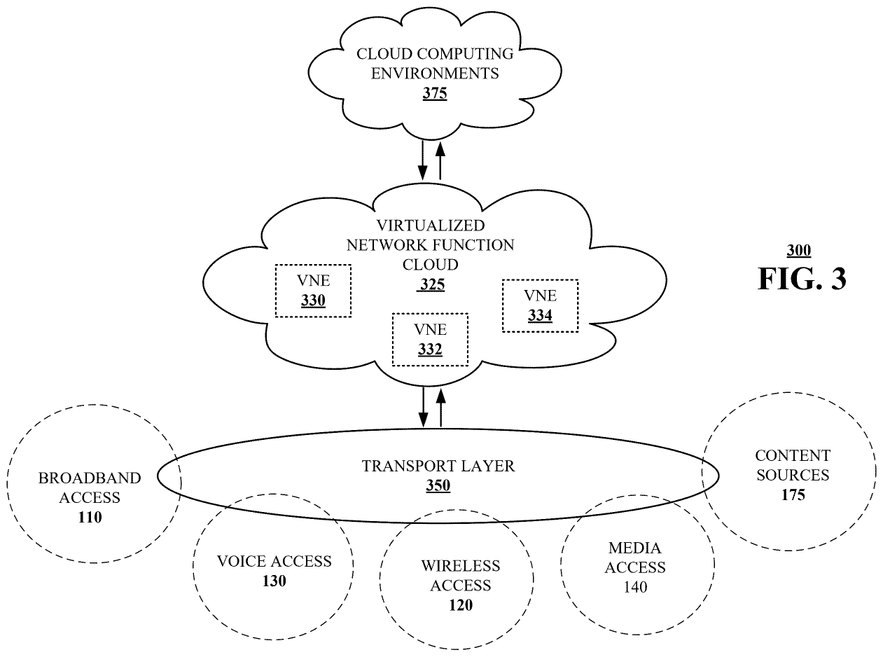

Referring now to FIG. 3, a block diagram is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, 2C, 2D, 2E, 2F, 2G and 3. For example, virtualized communication network 300 can facilitate in whole or in part receive network access parameters associated with a registration request from a user equipment; determine a mapping between a data network name and a plurality of available network functions deployed in a converged core network; select one or more network functions to provide service the user equipment; generate control signals to provision and establish sessions; and communicate the control signals to the one or more network functions selected.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. At other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

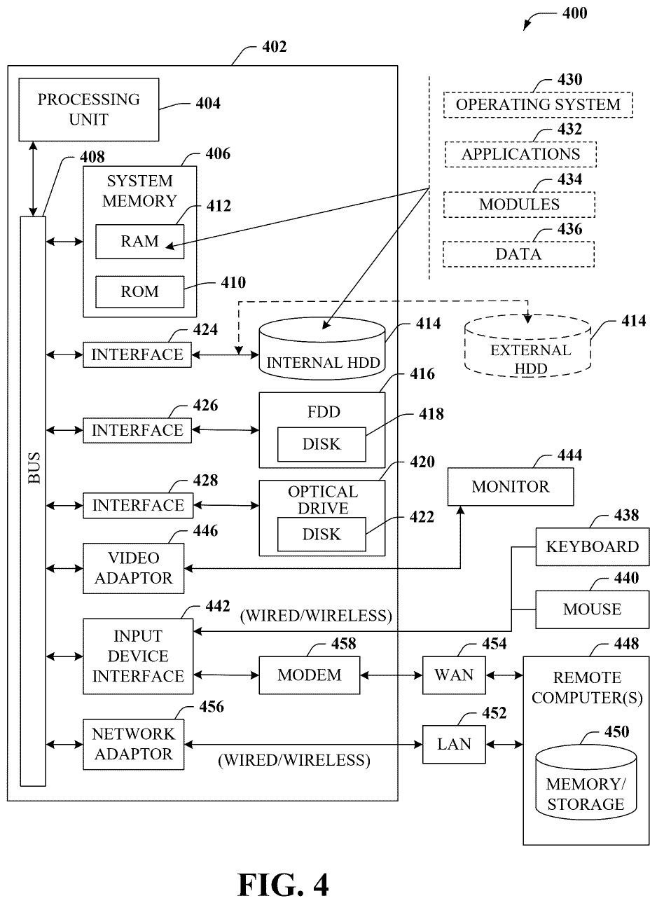

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a computing environment 400 suitable for implementing the various embodiments of the subject disclosure. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part receive network access parameters associated with a registration request from a user equipment; determine a mapping between a data network name and a plurality of available network functions deployed in a converged core network; select one or more network functions to provide service the user equipment; generate control signals to provision and establish sessions; and communicate the control signals to the one or more network functions selected.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, programming modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can also be connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof can be stored in the remote memory/storage device 450. It will be appreciated that the network connections shown are examples and other means of establishing a communications link between the computers can be used.

The computer 402 can be operable to communicate with any wireless devices or entities operatively disposed with wireless communication, e.g., a printer, scanner, desktop and/or portable computer, portable data assistant, communications satellite, any piece of equipment or location associated with a wireless detectable tag (e.g., a kiosk, news stand, restroom), and telephone. This can comprise Wireless Fidelity (Wi-Fi) and BLUETOOTH® wireless technologies. Thus, the communication can be a predefined structure to a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, dependable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

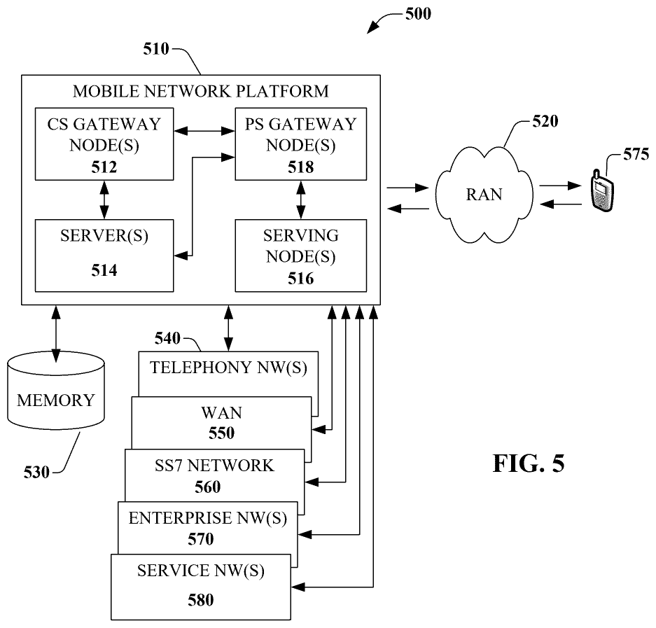

Turning now to FIG. 5, an embodiment of a mobile network platform 510 is shown that is an example of network elements 150, 152, 154, 156, and/or VNEs 330, 332, 334, etc. For example, mobile network platform 510 can facilitate in whole or in part receive network access parameters associated with a registration request from a user equipment; determine a mapping between a data network name and a plurality of available network functions deployed in a converged core network; select one or more network functions to provide service the user equipment; generate control signals to provision and establish sessions; and communicate the control signals to the one or more network functions selected. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provide services from external network(s) like networks operated by a disparate service provider; for instance, WAN 550 or Global Positioning System (GPS) network(s) (not shown). Provisioning server(s) can also provision coverage through networks associated with mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates substantially in the same manner as described hereinbefore.

In embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

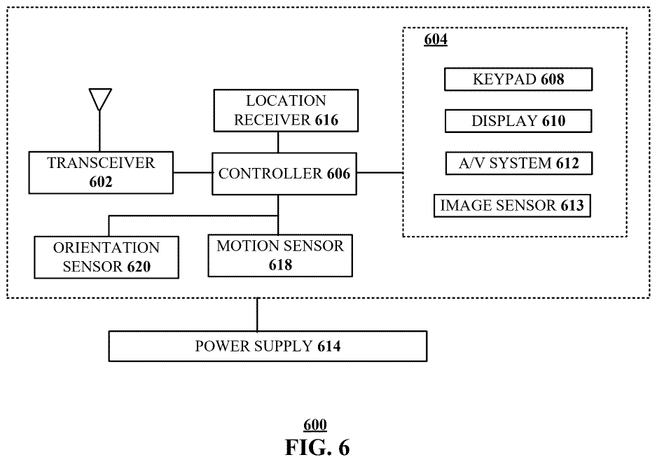

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part receive network access parameters associated with a registration request from a user equipment; determine a mapping between a data network name and a plurality of available network functions deployed in a converged core network; select one or more network functions to provide service the user equipment; generate control signals to provision and establish sessions; and communicate the control signals to the one or more network functions selected.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying the location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or non-volatile memory, or can comprise both volatile and nonvolatile memory, by way of illustration, and not limitation, volatile memory, non-volatile memory, disk storage, and memory storage. Further, nonvolatile memory can be included in read-only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, handheld computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications that can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, the use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. An apparatus, comprising:
a processing system including a processor; and
a memory configured to store executable instructions that, when executed by the processor, cause the apparatus to:
receive, via one or more interfaces, network access parameters associated with a registration request from a user equipment;
determine, based on the network access parameters and provisioning information for a data network name (DNN) of a data network, a mapping between the DNN and a plurality of available network functions deployed in a converged core network;
select one or more network functions from the plurality of available network functions to provide service the user equipment;
generate control signals to dynamically orchestrate provisioning and session establishment via the one or more network functions selected; and
communicate the control signals to the one or more network functions selected.

2. The apparatus of claim 1, wherein the apparatus is operable to support converged core network operations across multiple access technologies comprising 3GPP-based wireless access and non-3GPP or wireline access.

3. The apparatus of claim 1, wherein the network access parameters comprise a tracking area identifier (TAI), a radio access technology type, network slice information, or a combination thereof.

4. The apparatus of claim 1, wherein the one or more network functions are selected using a dynamic mapping algorithm that integrates slice awareness and energy efficiency criteria.

5. The apparatus of claim 4, wherein the dynamic mapping algorithm is further configured to utilize geographic location information of the user equipment to adjust the mapping between the DNN and the plurality of available network functions.

6. The apparatus of claim 4, wherein the dynamic mapping algorithm integrates energy efficiency metrics by evaluating real-time network load conditions to select one or more network functions that are energy efficient.

7. The apparatus of claim 4, wherein the dynamic mapping algorithm further comprises a module for re-evaluating the mapping between the data network name and the available network functions in response to variations in network load, user equipment mobility, energy consumption parameters, or a combination thereof.

8. The apparatus of claim 1, wherein the control signals comprise configuration commands for dynamically provisioning the one or more network functions selected and establishing session connectivity for the user equipment.

9. The apparatus of claim 1, wherein the provisioning information for the DNN is retrieved from a unified data management system associated by subscription data of the user equipment.

10. The apparatus of claim 1, wherein the plurality of available network functions include a Session Management Function and a User Plane Function that are optimized to support converged core network operations across wireless and wireline access technologies.

11. The apparatus of claim 1, wherein the processing system comprises a plurality of processors operating in a distributed computing environment.

12. A non-transitory machine-readable medium, comprising executable instructions that, when executed by a processing system including a processor, facilitate performance of operations, the operations comprising:
receive network access parameters associated with a registration request from a user equipment in a converged core network;
retrieve provisioning data for a data network name (DNN) from a unified data management system;
determine, based on the network access parameters, the provisioning data, and location-based information, a dynamic mapping between the DNN and a plurality of available network functions deployed in the converged core network;
select one or more network functions from the plurality of available network functions;
generate control signals to dynamically orchestrate provisioning and to establish session connectivity for the user equipment via the network functions selected; and
periodically re-evaluate the dynamic mapping by retrieving updated network performance metrics and geo-location data to adjust the dynamic mapping in response to variations in network load, energy consumption parameters, and endpoint mobility.

13. The non-transitory machine-readable medium of claim 12, wherein the network access parameters include a tracking area identifier, a radio access technology type, and network slice information.

14. The non-transitory machine-readable medium of claim 12, wherein the network functions are selected by a dynamic mapping algorithm that integrates slice awareness, energy efficiency criteria, and real-time network load conditions.

15. The non-transitory machine-readable medium of claim 14, wherein the dynamic mapping algorithm continuously optimizes selecting the network functions to enhance service quality and operational efficiency in a multi-access converged core network infrastructure.

16. The non-transitory machine-readable medium of claim 14, wherein the dynamic mapping algorithm is further configured to utilize geographic location information of the user equipment to adjust the dynamic mapping between the DNN and the plurality of available network functions.

17. The non-transitory machine-readable medium of claim 12, wherein the plurality of available network functions includes a Session Management Function and a User Plane Function that are optimized to support converged core network operations across wireless and wireline access technologies.

18. The non-transitory machine-readable medium of claim 12, wherein the processing system comprises a plurality of processors operating in a distributed computing environment.

19. A method, comprising:
receiving, by a processing system including a processor, a registration request from a user equipment, the registration request including network access parameters comprising a tracking area identifier, a radio access technology type, and network slice information for a network;
retrieving, by the processing system from a unified data management system, provisioning information associated with a data network name (DNN);
dynamically determining, by the processing system executing a dynamic mapping algorithm, a mapping between the DNN and a plurality of available network functions deployed in the network, the mapping being based on the network access parameters and geographic location data for the user equipment;
selecting, by the processing system based on the mapping, one or more network functions that satisfy predetermined criteria including slice awareness, energy efficiency, and real-time network load conditions;
generating, by the processing system, configuration commands to dynamically provision the network functions selected and to establish session connectivity for the user equipment; and
transmitting, by the processing system, the configuration commands to the network functions selected.

20. The method of claim 19, wherein the method further comprises periodically re-evaluating the mapping by obtaining updated network performance metrics, energy consumption parameters, and user equipment mobility data, and responsively adjusting the mapping.
